(19) United States
(12) Patent Application Publication
(10) Pub. No.: US 2003/0039403 A1
(43) Pub. Date: Feb. 27, 2003

(54) Method and system for user assisted defect removal

(76) Inventor: David R. Robins, Newton, MA (US)

Correspondence Address: Orlando Lopez, POLAROID CORPORATION, Patent Department, 784 Memorial Drive, Cambridge, MA, 02139, US

(21) Appl. No.: 09/939,221

(22) Filed: Aug. 24, 2001

(51) Int. Cl. G06T 5/00; G06K 9/40; G06K 9/46

(52) U.S. Cl. 382/275; 382/282; 382/190

(57) ABSTRACT

A user of a system to correct defects in a digital image is provided with the ability to select, add, or verify defect areas through user input in order to prevent false detection of defects and complement the detection of defects obtained by analyzing the image. The user input includes identifying points as defects, whether as single defects or as a line of points (referred to as a scratch defect), defining areas of the input image where the defect identification is restricted to that area or precluded from that area, deleting defects from the at least one defect map, including additional defects in the at least one defect map by identifying at least one points as a defect, and selecting an area from the defect map display image and displaying the input image data in that area.

### CROSS-REFERENCE TO RELATED APPLICATIONS

This application is related to commonly-owned and concurrently filed U.S. Patent Application ______ entitled “Method and Apparatus for Detection and Removal of Scanned Image Scratches and Dust” (Atty. Case No. 8516).

### BACKGROUND OF THE INVENTION

1. Field of the Invention

The present invention relates to image processing. More specifically, it relates to the detection and removal of defects in a digital image.

2. Background Description

Digital images often contain information that differs from the original image. Such information that differs from the original image constitutes defects in the digital image. In some instances, defects are caused by the imperfections of the digital acquisition system. For example, obstructions in the optical system of the digital acquisition device can introduce defects. Some typical causes of obstructions are dust and scratches in components of the optical system.

Other sources of defects are imperfections and extraneous matter on the surface of the input image. For example, an input image could be scratched or deformed.

Extraneous matter such as dust or particulates or fibers or fingerprints on the surface of the input image will be acquired as defects.

Since digital image processing techniques can be easily applied to a digital image, such techniques can be adapted to correct the defects in the image. A variety of image defect detection and correction methods have been applied.

Both hardware and software defect detection methods have been applied. Hardware defect detection methods include use of an infrared image channel to detect defects as in U.S. Pat. No. 5,266,805 (A. D. Edgar, “System and Method for Image Recovery”, Nov. 30, 1993) and in U.S. Pat. No. 6,075,590 (A. D. Edgar, “Reflection Infrared Surface Defect Correction”, Jun. 13, 2000). Another approach to defect detection using a second light source and the scattering properties of the image is described in WIPO Publication WO 00/46980 (M. Potucek et al., “Apparatus and Methods for Capturing Defect Data”, published Aug. 10, 2000). Both of these methods require additional hardware.

Both hardware and software defect detection methods detect defects using some fixed criterion. Depending on the severity of the defect, there is a finite likelihood of missing a defect or of falsely detecting a defect.

### SUMMARY OF THE INVENTION

It is the primary object of this invention to provide a user of a system to correct defects in a digital image with the ability to select, add, or verify defect areas through user input in order to prevent false detection of defects and complement the detection of defects obtained by analyzing the image.

To achieve these and other objects, one aspect of the invention includes a method for correcting defects in a input digital image, where the method comprises the steps of identifying the defects to form at least one defect map, generating an image comprising all defect maps superimposed on the input image (that image hereafter referred to as the defect map display image), accepting user input relating to the defect maps, and adjusting the values of the pixels in the input image.

The user input includes identifying points as defects, whether as single defects or as a line of points (referred to as a scratch defect), defining areas of the input image where the defect identification is restricted to that area or precluded from that area, deleting defects from the at least one defect map, including additional defects in the at least one defect map by identifying at least one points as a defect, and selecting an area from the defect map display image and displaying the input image data in that area.

Other aspects of this invention are the computer program product comprising a computer readable medium having computer readable code that causes a computer system to perform the above described methods, a digital image processing system utilizing the above described methods, and a digital image acquisition system that utilizes the above described methods to identify and correct defects.

Including user provided information can prevent false detection of defects and can complement the detection of defects obtained by analyzing the image.

Combining the aspects of this invention, the use of user provided information for defect identification, with methods of identification of defects comprising operating on the image (such as filtering the image) yields a defect identification method that is at least as accurate, and potentially more accurate, than methods requiring additional hardware components for the identification of defects. Including user identified defects in defect maps will result ia more comprehensive defect identification.

The methods of this invention can be applied to an input digital image provided by any device capable of providing a digital image. For example, the digital input image can be obtained from a scanner, a digital camera or any computer readable medium. Since the user can select points or areas of the input image to be corrected, defects can include any feature of the image to be corrected or modified. For example, the methods of this invention can be applied to remove wires and other unwanted elements from frames in digital versions of motion pictures. In this example, the methods of this invention can be used to produce special effects in motion pictures.

### DESCRIPTION OF THE DRAWINGS

The novel features that are considered characteristic of the invention are set forth with particularity in the appended claims. The invention itself, however, both as to its organization and its method of operation, together with other objects and advantages thereof will be best understood from the following description of the illustrated embodiment when read in connection with the accompanying drawings wherein:

FIG. 1 depicts an embodiment of an image acquisition system including an image processing system constructed according to this invention;

FIG. 1A depicts a block diagram of selected components of an embodiment of a processing module containing an image processing system constructed according to this invention;

FIG. 2 depicts a flowchart of an embodiment of a method, according to this invention, for identifying and correcting defects in an input digital image;

FIG. 3 is a graphical representation of an embodiment of means for a user to identify or preclude the correction of defects, or add or delete defects;

FIG. 4 is a graphical representation of an input digital image and a selected area in that image;

FIG. 5 is a graphical representation of an embodiment of a defect map display image;

FIG. 6 is a graphical representation of an embodiment of a defect map display image illustrating the selection of an area of observation.

### DETAILED DESCRIPTION

The present invention discloses a system and method for identifying and correcting defects in an input digital image in which effect of uncertainty in defect identification is mitigated by utilizing user provided information. The system and method of this invention, described below, takes into account the uncertainty of defect identification by identifying the defects to form at least one defect map, displaying the at least one defect map superimposed on the input digital image, and, then, accepting input related to the at least one defect map from a user.

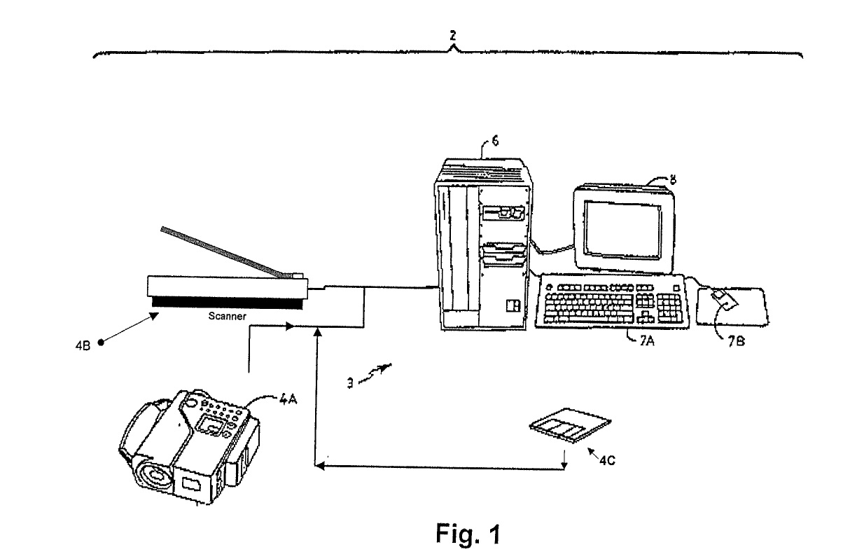

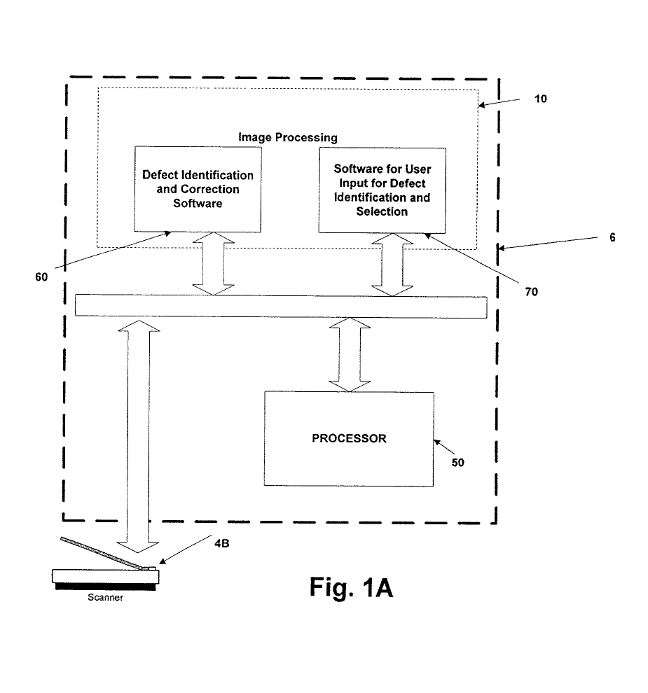

FIG. 1 depicts an embodiment of an image acquisition system 2 including an image processing system 10 (shown in FIG. 1A) constructed according to this invention. Referring to FIG. 1, the image acquisition system 2, in one embodiment, includes a computer system 3, and means for acquiring a digital image such as acquisition devices 4A and 4B (digital camera 4A and scanner 4B) and computer readable media 4C.

The computer system 3, in the embodiment shown in FIG. 1, includes a processing module 6, input components such as a keyboard 7A and/or a mouse 7B and output components such as a video display device 8. A block diagram of selected components of an embodiment of a processing module containing an image processing system 10 constructed according to this invention is shown in FIG. 1A. Referring to FIG. 1A, the processor 50 reads the software (computer readable code) 60 and 70 which causes the processor 50 to perform the methods of this invention. The computer readable code 60 and 70 is embodied in computer readable media (not shown). In the embodiment shown in FIG. 1A, the image processing system 10 is comprised of Defect Identification and Correction Software 60, which provides means for identifying the defects and means for defect correction, and Software for User Input for Defect Identification and Selection 70. Computer readable media (not shown) such as memory and mass storage devices, such as disk and/or tape storage elements (not separately shown), are typically included in processing module 6.

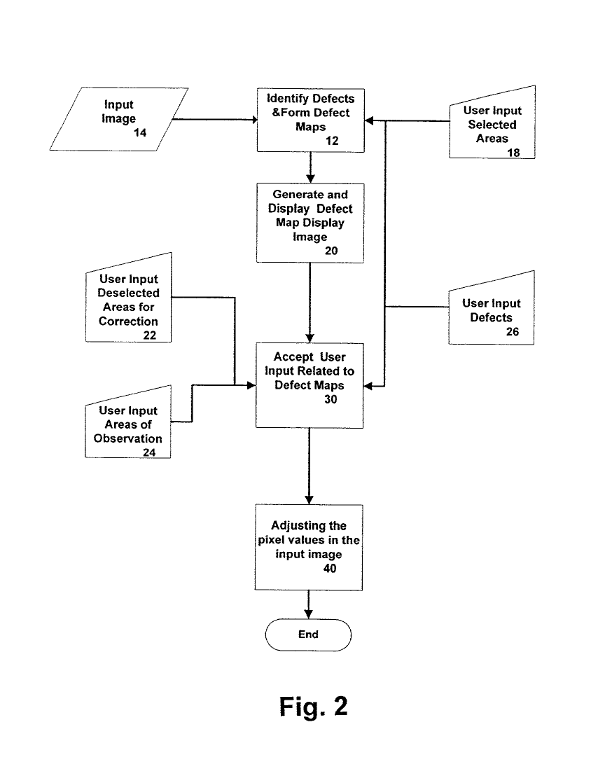

A flowchart of an embodiment of a method, according to this invention, for identifying and correcting defects in an input digital image 14 is shown in FIG. 2. Referring to FIG. 2, the input digital image 14, comprised of a multiplicity of pixels, each pixel having at least one given value selected from at least one of many image description parameters, provides the initial data for the method. For example, the image could be represented by R, G, B values or Y, u, v values or any other color space representation or could be a monochrome image. User input can define, prior to step 12, at least one area of the acquired digital image as a selected area 18, wherein the identifying of the defects to form at least one defect map is restricted to or precluded from the selected area. From the input image 14, the defects are identified (step 12, FIG. 2), forming at least one defect map. User input can also define at least one point as a defect 26, at least one point defining a user input defect pixel. The defect maps are comprised of adjacent defect pixels, defect pixels being input digital image pixels. In a tri-color image, the defect identification can be applied to all three colors or to the luminance (Y) component only.

One embodiment of the method for identifying the defects is detailed in U.S. Patent Application ______ entitled “Method and Apparatus for Detection and Removal of Scanned Image Scratches and Dust” (Atty. Case No. 8516). Other embodiments of the method for identifying the defects, requiring additional hardware in the acquisition device 4B, are described in U.S. Pat. No. 6,075,590 (A. D. Edgar, “Reflection Infrared Surface Defect Correction”, Jun. 13, 2000) and in WIPO Publication WO 00/46980 (M. Potucek et al., “Apparatus and Methods for Capturing Defect Data”, published Aug. 10, 2000). Still, other embodiments of the method for identifying the defects, implemented in software, compare pixel values to identify defects.

Once all the defect maps have been identified, the identified defect maps are superimposed on the input digital image, forming a defect map display image (step 20, FIG. 2). The user can select an area of the defect map display image as an area of observation 24. Upon issuing a display command (from a pop-up menu, for example), the user can display a section of the input digital image 14 located under the defect map. For example, the user can obtain pixel information by means of a cursor or pointer. When the user moves the cursor or pointer to a location in the section of the image to be displayed, a palette or window displays the location of the cursor or pointer and the at least one given value selected from at least one of many image description parameters (for example, R, G, B values). Alternatively, the user can define at least one area of the input digital image as a deselected area for correction 22, where the adjusting of the pixel values in the input image 14 (step 20, FIG. 2) is precluded in the deselected areas. The user can also select at least one defect point from the defect map display image, these selected points being precluded from the correction of defects. These selected points are removed from the corresponding defect map.

Finally, the pixel values in the input image 14 are adjusted to correct the defects in each defect map (step 40, FIG. 2). One embodiment of the method for correcting the values in each defect map is detailed in U.S. Patent Application ______ entitled “Method and Apparatus for Detection and Removal of Scanned Image Scratches and Dust” (Atty. Case No. 8516). Other methods for correcting the values in each defect map include interpolating from the pixels in the surrounding region, replacing the values in each defect map with the mean or median value obtained using a surrounding region.

Details of one embodiment of this invention are given below.

Sample Embodiment

A specific embodiment is detailed below for an application developed under an operating system incorporating a graphical user interface comprising windows, icons, menus, and pointing devices (Windows 95, 98, NT, ME, 2000 for example).

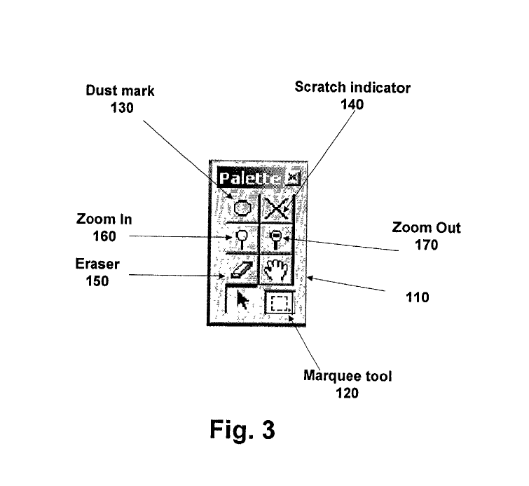

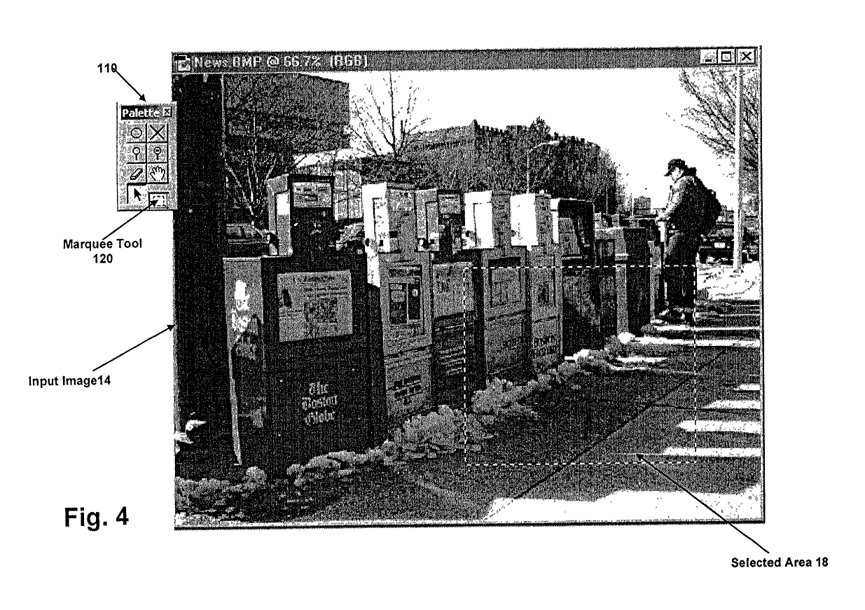

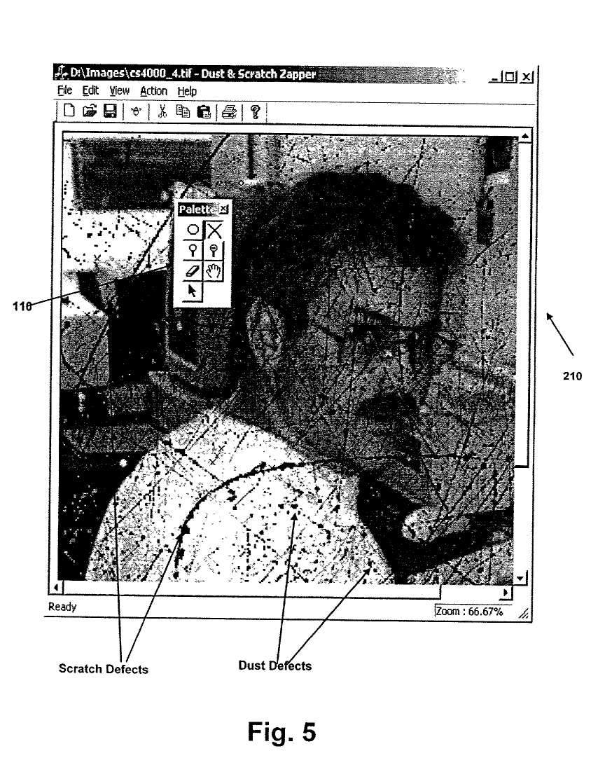

An input digital image 14 (for example, that shown in FIG. 4) is acquired via an acquisition device, such as scanner 4B or digital camera 4A, or from a computer readable medium 4C. The digital image 14 is displayed in the video display device 8. The display image comprises a “palette” 110 (shown in FIG. 3), which constitutes means for a user to identify or preclude the correction of defects, or add or delete defects. The palette 110 is shown in FIG. 4 displayed in the same window as the input image 14 but adjacent to a border of the image. Alternatively, the palette could be located in the interior of the image (as in FIG. 5). In yet another embodiment, the palette would appear following a command (such as Correct Defects) from a menu.

The palette 110 comprises several “tools” which allow the user to select an area of the image (Marquee tool 120), add defects (Dust mark tool 130 and Scratch indicator tool 140) or delete defects. (Eraser tool 150). By selecting the desired “tool” (for example, by a “click” of the mouse 7B on the symbol for the tool in the palette), an icon corresponding to the tool appears in the image. For the Eraser tool, an embodiment of the icon would be an eraser symbol; for the marquee, an embodiment of the icon would be a cross-hair symbol.

By selecting the icon (for example, by “click” of the mouse 7B on the icon for the Dust mark or by a “click”, hold and drag of the mouse 7B for the eraser, the crosshair or the Scratch icon), the user can perform the desired operation.

To define at least one area of the digital image 14 as a selected area 18, the marquee tool 120 is selected, using the keyboard 7A and/or the mouse 7B, from the palette 110 and is used. A menu of commands (not shown), such as a pop-up menu, appears when the user gives a designated input (for example, when the user “clicks” on the selected area 18 with the mouse 7B or gives a designated keyboard 7A input). The command menu includes commands for identifying the defects (Identify defects, for example), and precluding the identification of defects (Do not identify, for example).

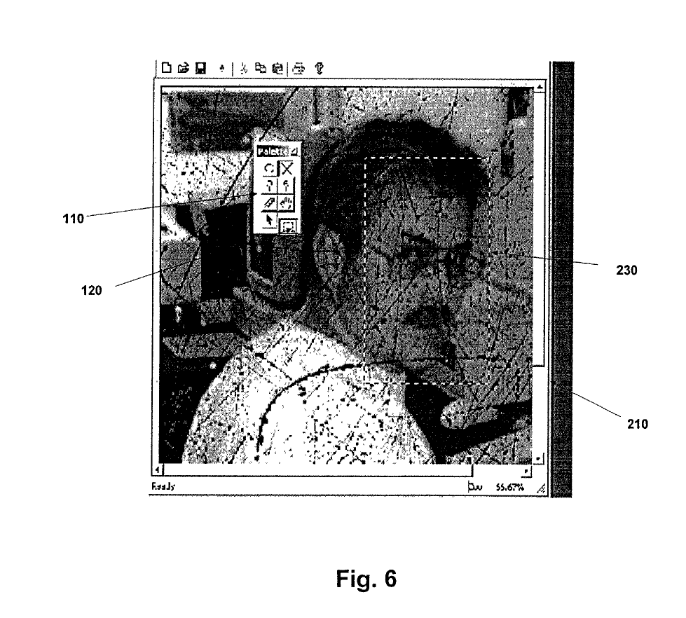

The defects are then identified by a defect identifying method such as those described above. Once all the defect have been identified, the identified defect are superimposed on the input digital image, forming a defect map display image 210 (shown in FIG. 5). Using the dust mark tool 130 in the palette 110 for point defects or the scratch indicator tool 140 in the palette 110 for a number of defects, the user can identify at least one point or a series of points (a scratch) as additional defects. Using the marquee tool 120, the user can select an area of the defect map display image as an area of observation 24 (see FIG. 6). Upon issuing a display command (from the pop-up menu, for example), the user can display a section of the input digital image located under the defect map display image in the area of observation. In one embodiment, the user can obtain pixel information by means of a cursor or pointer. When the user moves the cursor or pointer to a location in the section of the image to be displayed, a palette or window displays the location of the cursor or pointer and the at least one given value selected from at least one of many image description parameters (for example, R, G, B values or C M Y K values). Alternatively, using a deselect command (from the pop-up menu, for example) on an area defined with the marquee tool 120, the user can define at least one area of the input digital image as a deselected area for correction 22. The adjusting of the pixel values in the input image 14 (step 20, FIG. 2) is precluded in the deselected areas.

Finally, the pixel values in the input image 14 are adjusted to correct the defects in each defect map (step 40, FIG. 2).

A computer readable code implementing the above described method for correcting defects in a input digital image, embodied in a computer readable medium, constitutes one embodiment of a digital image processing system for correcting defects in the input digital image. The computer readable code provides the means to implement the method.

It should be appreciated that the various embodiments described above are provided merely for purposes of example and do not constitute limitations of the present invention. Rather, various other embodiments are also within the scope of the claims, such as the following. The system of FIGS. 1 and 1A can be implemented with more than one processor, with a dedicated processor for some of the tasks and another processor for the remainder of the tasks or any combination thereof. The identifying of additional defects can occur before the generation of the defect map display image. Pointing devices other than mouse-like devices can be used (such as voice activation, optical pointing devices).

In general, the techniques described above may be implemented, for example, in hardware, software, firmware, or any combination thereof. The techniques described above may be implemented in one or more computer programs executing on a programmable computer including a processor (or more than one processor), a storage medium readable by the processor (including, for example, volatile and non-volatile memory and/or storage elements), at least one input device, an acquisition device or means to accept an input image and at least one output device. Program code may be applied to data entered using the input device to perform the functions described and to generate output information. The output information may be applied to one or more output devices.

It should be apparent that the methods of this invention could be implemented as a computer program on a computer having an operating system that provides a user interface. Graphical interfaces such as provided by Windows 2000, ME, 98, 95, MAC OS, Unix X Windows or an operating system providing a user interface could be used to implement the methods of this invention.

Elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may be a compiled or interpreted programming language. Each computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output.

The acquisition of the input digital image can occur at a location remote from the processor and rendering display. The operations performed in software utilize instructions (“code”) that are stored in computer-readable media and store results and intermediate steps in computer-readable media. The input digital image may also be acquired from a computer readable medium.

Common forms of computer-readable media include, for example, a floppy disk, a flexible disk, hard disk, magnetic tape, or any other magnetic medium, a CDROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read. Electrical, electromagnetic or optical signals that carry digital data streams representing various types of information are exemplary forms of carrier waves transporting the information.

Other embodiments of the invention, including combinations, additions, variations and other modifications of the disclosed embodiments will be obvious to those skilled in the art and are within the scope of the following claims.

What is claimed is:

1. A method for correcting defects in an input digital image, said input digital image comprised of a plurality of pixels, each pixel having at least one given value selected from at least one of a plurality of image description parameters, said method comprising the steps of:
(A) identifying defect pixels from the input digital image to form at least one defect map, said defect map comprised of at least one defect pixel;
(B) displaying the at least one defect map superimposed on the input digital image, said superposition resulting in a defect map display image;
(C) accepting input related to the at least one defect map from a user;
(D) adjusting the values of the pixels in the input image.

2. The method of claim 1 further comprising the step of:
identifying at least one point as a defect, said points defining at least one defect pixel, said identification being performed by a user.

3. The method of claim 1 where the user input comprises defining at least one area of the input digital image as a selected area, the adjusting of the values of the pixels being precluded in said selected areas.

4. The method of claim 1 further comprising the steps of:
selecting, prior to step (C), an area of the defect map display image, said selected area being an area of observation;
displaying, upon receipt of a display command from the user, a section of the input digital image located under the defect map display image in said area of area of observation.

5. The method of claim 1 where the user input comprises:
selecting at least one defect point from the defect map display image, said selected points being precluded from step (D).

6. The method of claim 5 further comprising the step of:
removing said selected points from the corresponding defect map.

7. The method of claim 1 further comprising the step of:
defining, prior to step (A), at least one area of the input digital image as a selected area;
and, where in the identifying of the defects to form at least one of a plurality of defect maps, the identifying is restricted to said selected areas.

8. The method of claim 1 further comprising the step of:
defining, prior to step (A), at least one area of the input digital image as a selected area;
and, where in the identifying of the defects to form at least one of a plurality of defect maps, the identifying is precluded said selected areas.

9. A computer program product comprising:
a computer readable medium having computer readable code embodied therein for correcting defects in a input digital image, said input digital image comprised of a plurality of pixels, each pixel having at least one given value selected from at least one of a plurality of image description parameters, said code causing a computer system to:
identify defect pixels to form at least one defect map, said defect maps comprised of at least one defect pixel, said defect pixels being input digital image pixels; and
display the at least one defect map superimposed on the input digital image, said superposition resulting in a defect map display image; and
accept input related to the defect map from a user; and
adjust the values of the pixels.

10. The computer program product of claim 9 where, the computer readable code further causes the computer system to:
identify at least one points as a defect, said points defining the defect pixels, said identification being based on input from a user.

11. The computer program product of claim 9 where, the computer readable code that causes the computer system to accept input related to the defect map from a user further causes the computer system to:
define at least one area of the input digital image as a selected area and where the adjusting of the values of the pixels is precluded in said selected areas.

12. The computer program product of claim 9 where, the computer readable code further causes the computer system to:
select, prior to accepting input related to the defect map from a user, an area of the defect map display image, said selected area being an area of observation; and
display, upon receipt of a display command from the user, a section of the input digital image located under the defect map display image in said area of area of observation.

13. The computer program product of claim 9 where, the computer readable code further causes the computer system to:
define, prior to identifying the defects to form at least one of a plurality of defect maps, at least one areas of the input digital image as a selected area;
and, where in the identifying of the defects to form at least one of a plurality of defect maps, the identifying is restricted to said selected areas.

14. The computer program product of claim 9 where, the computer readable code further causes the computer system to:
define, prior to identifying the defects to form at least one of a plurality of defect maps, at least one area of the input digital image as a selected area;
and, where in the identifying of the defects to form at least one defect map, the identifying is precluded from said selected areas.

15. The computer program product of claim 9 where, the computer readable code that causes the computer system to accept input related to the defect map from a user further causes the computer system to:
select at least one defect point from the defect map display image, said selected points being precluded from the adjusting of the values of the pixels.

16. The computer program product of claim 15 where, the computer readable code further causes the computer system to:
remove said selected points from the corresponding defect map.

17. A digital image processing system for correcting defects in a input digital image, said input digital image comprised of a plurality of pixels, each pixel having at least one given value selected from at least one of a plurality of image description parameters, said system comprising:
means for identifying defect pixels to form at least one defect map, said defect maps comprised of defect pixels, said defect pixels being input digital image pixels; and,
means for displaying the at least one defect map superimposed on the input digital image, said superposition resulting in a defect map display image; and,
means for accepting input related to the defect map from a user; and,
means for adjusting the values of the pixels in the input image.

18. The system of claim 17 further comprising:
means for identifying at least one point as a defect, said points defining the defect pixels, said identification being performed by a user.

19. The system of claim 17 wherein the means for accepting input related to the defect map from a user comprise:
means for defining at least one area of the input digital image as a selected area and where the adjusting of the values of the pixels is precluded in said selected areas.

20. The system of claim 17 further comprising:
means for selecting, prior to accepting input related to the defect map from a user, an area of the defect map display image, said area being an area of observation;
means for displaying, upon receipt of a display command from the user, a section of the input digital image located under the defect map display image in said area of observation.

21. The system of claim 17 wherein the means for accepting input related to the defect map from a user comprise:
means for selecting at least one defect point from the defect map display image, said selected points being precluded from the adjusting of the values of the pixels in the input image.

22. The system of claim 21 further comprising:
means for removing said selected points from the corresponding defect map.

23. The system of claim 17 further comprising:
means for defining, prior to identifying the defects to form at least one defect map, at least one area of the input digital image as a selected area;
and, where in the identifying of the defects to form at least one defect map, the identifying is restricted to said selected areas.

24. The system of claim 17 further comprising:
means for defining, prior to for identifying the defects to form at least one defect map, at least one area of the input digital image as a selected area;
and, where in the identifying of the defects to form at least one defect map, the identifying is precluded from said selected areas.

25. A digital image acquisition system comprising:
means for acquiring an input digital image, said image comprised of a plurality of pixels, each pixel having at least one given value selected from at least one of a plurality of image description parameters; and
at least one digital processor;
a computer readable medium having computer readable code embodied therein for correcting defects in said input digital image, said code causing said at least one digital processor to:
identify the defects to form at least one defect maps, said defect maps comprised of defect pixels, said defect pixels being input digital image pixels; and,
display the at least one defect map superimposed on the input digital image, said superposition resulting in a defect map display image; and
accept input related to the defect map from a user; and

26. The digital image acquisition system of claim 24 wherein the computer adjust the values of the pixels in the input image.
readable code further causes the at least one digital processor to:
identify at least one point as a defect, said points defining the defect pixels, said identification being performed by a user.

27. The digital image acquisition system of claim 24 wherein the computer readable code that causes the at least one digital processor to accept input related to the defect map from a user further causes the at least one digital processor to:
define at least one area of the input digital image as an selected area, the adjusting of the values of the pixels in each region of interest being precluded in said selected areas.

28. The digital image acquisition system of claim 24 wherein the computer readable code further causes the at least one digital processor to:
select, prior to accepting input related to the at least one defect map from a user, an area of the defect map display image, said selected area being an area of observation; and
display, upon receipt of a display command from the user, a section of the input digital image located under the defect map display image in said area of area of observation.

29. The digital image acquisition system of claim 24 wherein the computer readable code that causes the at least one digital processor to accept input related to the defect map from a user further causes the at least one digital processor to:
select at least one defect point from the defect map display image, said selected points being precluded from the adjusting the values of the pixels in the input image.

30. The digital image acquisition system of claim 29 wherein the computer readable code further causes the at least one digital processor to:
remove said selected points from the corresponding defect map.

31. The digital image acquisition system of claim 24 wherein the computer readable code further causes the at least one digital processor to:
define, prior to the identifying the defect pixels from the input digital image to form at least one defect map, at least one area of the input digital image as a selected area;
and, where in the identifying of the defect pixels to form at least defect map, the identifying is restricted to said selected areas.

32. The digital image acquisition system of claim 24 wherein the computer readable code further causes the at least one digital processor to:
define, prior to the identifying the defect pixels from the input digital image to form at least one defect map, at least one area of the input digital image as a selected area;
and, where in the identifying of the defect pixels to form at least defect map, the identifying is restricted to said selected areas.
